(19) United States
(12) Patent Application Publication
(10) Pub. No.: US 2013/0162762 A1
(43) Pub. Date: Jun. 27, 2013

(54) GENERATING A SUPPLEMENTAL VIDEO STREAM FROM A SOURCE VIDEO STREAM IN A FIRST OUTPUT TYPE FORMAT USED TO PRODUCE AN OUTPUT VIDEO STREAM IN A SECOND OUTPUT TYPE FORMAT

(71) Applicant: Oren Samuel Cohen, Van Nuys, CA (US)

(72) Inventor: Oren Samuel Cohen, Van Nuys, CA (US)

(73) Assignee: 2DINTO3D LLC, Van Nuys, CA (US)

(21) Appl. No.: 13/335,558

(22) Filed: Dec. 22, 2011

(51) Int. Cl. H04N 11/20; H04N 13/00

(52) U.S. Cl. 348/42; 348/453; 348/E15.001; 348/E09.037

(57) ABSTRACT

Provided are a computer program product, system, and method for processing a source video stream of frames of images providing a first type of output format to generate a supplemental video stream, wherein the source video stream and the supplemental video stream are processed by a video processor to produce an output video stream having a second type of output format. The source video stream has a plurality of frames of digital images comprising an array of pixels in the first type of output format. The frames of the source video stream are processed by transforming color values for the pixels in the images in the frames to different color values to produce a modified video stream whose frames are merged with the corresponding frames in the source video stream to produce the supplemental video stream.

### BACKGROUND OF THE INVENTION

1. Field of the Invention

The present invention relates to a computer program product, system, and method for generating a supplemental video stream from a source video stream in a first output type format used to produce an output video stream in a second output type format.

2. Description of the Related Art

Increased demand for three-dimensional (3D) video content has led to the development of various tools and techniques for converting two-dimensional (2D) videos into 3D videos. This demand for 3D content is fueled by the development of high quality 3D video viewing systems, such as auto-stereoscopic 3D displays, which are television and computer displays that do not require viewers to wear special 3D glasses, enhanced viewing systems that utilize high quality 3D glasses, and by the popularity and public exposure to 3D content in the form of blockbuster movies and popular video games. The increased popularity of 3D media increases the demand for 3D content and, in turn, the demand for software tools that can efficiently convert the vast libraries of digital 2D videos into 3D videos for 3D viewing.

The 2D into 3D conversion process receives as input a digitized 2D video stream and creates a 3D video stream that appears to have images with depth when viewed with a 3D video playback technology. A common technique for converting 2D video to 3D video involves the use of a depth map which comprises a video stream of frames corresponding to the frames in the 2D video content that provides depth information for the pixels in the frames. The depth map frames contain information relating to the distance of the surfaces of scene objects from a viewpoint. The depth map provides separate grayscale images for the frames in the 2D video content having the same dimensions with various shades of gray to indicate the depth of every part of the frame. For instance, in some implementations, lighter shades of grey indicate that the object is more in the viewing foreground and darker shades of grey indicate the object is more in the background. The 3D conversion tool processes the 2D video stream along with the depth map to generate the 3D video stream. An example of a product that performs 3D conversion using a depth map is the WSWvx BlueBox 3D content creation suite from Philips 3D Solutions (PHILIPS is a registered trademark of Koninklijke Philips Electronics N.V. in the United States and other countries).

The process to create an accurate and useful depth map for the 3D conversion process is very labor intensive. This process may involve the user manually creating the depth map for each frame based on the content of the frame in the 2D video. Certain conversion tools use estimation algorithms to generate depth map frames based on reference frames in a shot. This allows the user to provide the depth map for a couple of reference frames per shot, like the start and end frames in a shot sequence, and then the 3D conversion tool uses estimation algorithms to generate the depth map for the intervening frames based on the user provided depth map frames and the video content.

The widespread adoption of 3D conversion tools has been limited by the substantial time and labor needed to create accurate depth maps and the lack of available estimation tools that produce depth maps that result in high quality 3D output. For these reasons, 3D conversion tool developers are continually seeking improved techniques for automatically generating depth maps that minimize user involvement, so that 2D video streams can be rapidly converted to 3D videos to meet the growing demand for 3D content.

Accordingly, there is a need in the art for improved techniques for generating the depth maps used in the 2D-to-3D video conversion processes.

### SUMMARY

Provided are a computer program product, system, and method for processing a source video stream of frames of images providing a first type of output format to generate a supplemental video stream, wherein the source video stream and the supplemental video stream are processed by a video processor to produce an output video stream having a second type of output format. The source video stream has a plurality of frames of digital images comprising an array of pixels in the first type of output format. The frames of the source video stream are processed by transforming color values for the pixels in the images in the frames to different color values to produce a modified video stream having frames corresponding to the frames in the source video stream;. The frames in the source video stream are merged with the corresponding frames in the modified video stream to produce merged frames in the supplemental video stream for use with the source video stream in producing the output video stream in the second type of output format.

### BRIEF DESCRIPTION OF THE DRAWINGS

FIG. 1 illustrates an embodiment of a video processing computing environment.

FIG. 2 illustrates an embodiment of a video pre-processor flow and components.

FIGS. 3a, 3b, and 3c illustrate an example of frames processed according to the described video pre-processor operations.

FIG. 4 illustrates an embodiment of a video pre-processor project container.

FIG. 5 illustrates an embodiment of segment information included in the project container of FIG. 4

FIG. 6 illustrates an embodiment of default parameters used during the video pre-processor operations.

FIG. 7 illustrates an embodiment of an overlay mapping used during the video pre-processor operations.

FIG. 8 illustrates an embodiment of a luminance mapping used during the video pre-processor operations.

FIG. 9 illustrates an embodiment of a desaturation mapping used during the video pre-processor operations.

FIG. 10 illustrates an example of an overlay mapping.

FIG. 11 illustrates an example of a luminance mapping.

FIG. 12 illustrates an example of a desaturation mapping.

FIG. 13 illustrates an embodiment of operations to generate a supplemental video stream, such as a depth map.

FIG. 14 illustrates an embodiment of a graphical user interface (GUI) used in the creation of the supplemental video stream.

FIG. 15 illustrates an embodiment of operations to modify the luminance of images in the source video stream as part of the process to generate the supplemental video stream.

FIG. 16 illustrates an embodiment of a GUI used in the operations to modify the luminance of images in the source video stream.

FIG. 17 illustrates an embodiment of operations to desaturate frames in the source video stream as part of the process to generate the supplemental video stream.

FIG. 18 illustrates an embodiment of a GUI used in the operations to desaturate frames.

FIG. 19 illustrates an embodiment of operations to overlay frames 15 illustrates an embodiment of operations to overlay frames as part of the process to generate the supplemental video stream.

FIG. 20 illustrates an embodiment of a GUI used in the operations to overlay the frames.

FIG. 21 illustrates an embodiment of a cloud computing environment.

FIG. 22 illustrates a computer architecture used with the described embodiments.

### DETAILED DESCRIPTION

Described embodiments provide techniques to generate a supplemental video stream, such as a depth map, used in converting a source video stream in a first type of output format, such as 2D video, into an output video stream in a second type of format, such as a 3D video. The described embodiments process the frames in the source video stream to produce a modified video stream having frames corresponding to the frames in the source video stream. This conversion process may involve an inversion of the color values for the pixels in the frames in the source video stream as well as a desaturation of the color values to produce the modified video stream. Further, the luminance of pixels in the frames of the source video stream may be adjusted to control the generation of the supplemental video stream, such as by providing depth information for selected objects in the source video stream. The frames in the modified video stream are then merged with the frames in the source video stream, such as by utilizing an overlay process, to form the supplemental video stream, such as a depth map. This supplemental video stream may then be supplied to a video process which receives as input both the source video stream and the supplemental video stream to produce an output video stream having a second type of output format, e.g., 3D, different from the first type of output format of the source video stream, e.g., 2D.

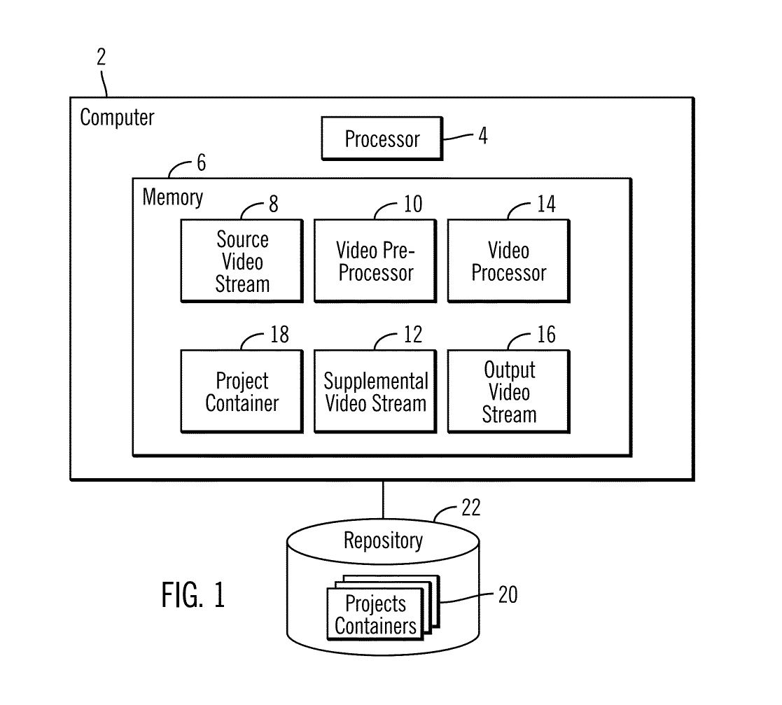

FIG. 1 illustrates an embodiment of a video processing computing environment including a computer 2 having a processor 4, and memory 6 with video processor components including a source video stream 8 in a first type of output format, such as a 2D video format, subject to preprocessing by a video pre-processor 10 to transform the source video stream into a supplemental video stream 12 that is used by the video processor 14 to convert the source video stream 8 into an output video stream 16 in a second type of output format, such as a three dimensional (3D) video format. The video pre-processor 10 may store configuration settings and information on the source video stream 8 and any generated supplemental video stream 12 in a project container 18. The video pre-pre-processor 10 may store multiple project containers 20 generated for one or more source video streams 8 in a storage repository 22.

The source video stream 8 may comprise a sequence of still images in frames in an output type of format, such as a 2D video. The sequence of frames in the source video stream may form one or more shots. A shot comprises a segment of footage, or consecutive frames, depicting a sequence of an activity or happening. The source video stream 8 content may comprise video shot using a video camera, computer animation, computer generated graphics, a combination of live video and computer graphics, etc. The output video stream 16 may be in an output type of format such as 3D video format. In embodiments where the video processor 14 converts a 2D video stream to a 3D video stream, the supplemental video stream 12 may comprise a depth map, where the frames in the supplemental video stream 12 provide depth information for the corresponding frames in the source video stream 8. For instance, the supplemental video stream 12 may comprise a grayscale depth map having frames providing depth information for pixels in the corresponding frames in the source video stream 8. In one embodiment, lighter colors for the pixel values provide depth information indicating the pixels are more to the forefront of the 3D image and the darker colors for the pixel values provide depth information indicating the pixel as more to the background of the 3D image. Alternative embodiments may use different grayscale coloring schemes to indicate pixels as closer or further away from the view point.

The source video stream 8 may be stored in a digital video format such as Moving Picture Experts Group (MPEG), (e.g., MPEG-1, MPEG-2, MPEG-3, MPEG-4), Flash (FLV), DVD, Blu-ray, QuickTime (MOV), Audio Video Interleave (AVI), Windows Media Video (WMV), Advanced Systems Format (ASF), etc. The output video stream 16 may be encoded in a digital video format for storing a 3D video stream content. For instance, the frames in the output video stream 16 may be in a format utilizing color shifting, where each frame has a pair of stereoscopic anaglyph images, e.g., right eye and left eye. The output video stream 16 may be in an encoding or format that includes frames having 3D content, such as AVI, MPEG, WMV, ASF, FLV, MOV, etc. Alternatively the output video stream 16 may utilize an enhanced video stream coding such as 2D plus depth, 2D plus delta, 2D+Metadata, Stereoscopic 3D (S3D), etc. In 2D plus depth video format embodiment, the output video stream 16 would comprise the source video stream 8 of frames having 2D images and the supplemental video stream 12 having frames providing depth information for the corresponding frames in the source video stream 8.

The video processor 14 may process the source video stream 8 and the supplemental video stream 12 to produce the 3D output video stream 16 providing an encoding that can be rendered in 3D output on a digital video player suitable for reproducing 3D images, such as a 3D or stereoscopic video player, where the 3D viewing may require 3D shutter glasses or a 3D viewing system, such as an auto-stereoscopic display.

In one embodiment, the video processor 14 for performing the conversion to the output format, such as 3D, may comprise the Philips WOWvx BlueBox 3D creation suite or other similar products, that converts the input source video stream 8 and supplemental video stream 12 comprising depth information into a 3D output video stream 16 capable of being rendered as 3D output using a 3D video player. In alternative embodiments, the video processor 14 may perform video processing of the source video stream other than 3D conversion using the supplemental video stream that may include depth or other video processing information.

The repository 22 may be implemented in storage media in one or more storage devices known in the art, such as interconnected hard disk drives (e.g., configured as a DASD, RAID, JBOD, etc.), solid state storage devices (e.g., EEPROM (Electrically Erasable Programmable Read-Only Memory), flash memory, solid state disks (SSDs), flash disk, storage-class memory (SCM)), electronic memory, etc. The computer 2 may connect to the repository 22 via a network connection (e.g., Intranet, Internet, Local Area Network (LAN), Storage Area Network (SAN), etc.), a bus interface or via a cable or other connection.

The computer 2 may comprise a suitable computer, such as a desktop, server, laptop, tablet computer, telephony device, smart phone, mainframe, etc. The memory 6 may comprise one or more memory devices to store programs executed by the processor 4, such as a Dynamic Random Access Memory (DRAM), Random Access Memory (RAM), cache, Flash Memory, Solid State Device (SSD), etc.

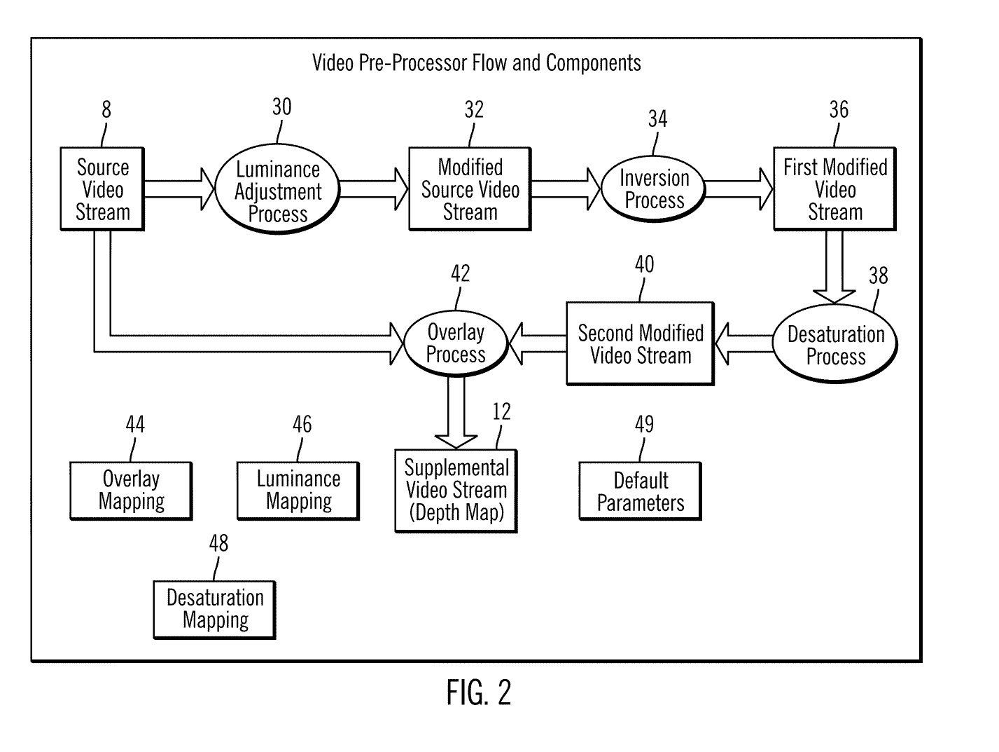

FIG. 2 illustrates a flow of the video pre-processor 10 operations in embodiments where the supplemental video stream 12 comprises a depth map providing depth information for the pixels in the source video stream 8. The video pre-processor 10 implements graphic processes including a luminance adjustment process 30, an inversion process 34, a desaturation process 38, and an overlay process 42. The processes 30, 32, 34, and 38 and objects 8, 12, 32, 36, 40, 44, 46, 48, and 50 may be implemented in the memory 6.

The luminance adjustment process 30 interacts with a user of the video pre-processor 10 to adjust the luminance of pixels in the frames of the source video stream 8 to allow the user to control the depth information for objects comprising the selected pixels. If the user selects to invoke the luminance adjustment process 30, then the result is a modified source video stream 32 comprising the source video stream 8 with frames having pixels with a user adjusted luminance. If the user does not adjust the luminance of pixels, then the modified source video stream 32 is the same as the source video stream 8. Adjusting the luminance effects the depth information generated for those pixels. In further embodiments, the luminance adjustment process 30 may adjust other color components, such as chrominance, etc.

The inversion process 34 performs an inversion of the color values for the pixels in the modified or unmodified source video stream 32. The pixels in the source video stream 32 may have color or grayscale values. For instance, if the color values of the pixels are expressed in RGB color, then the inversion process 34 may be performed by converting the pixel values to the inverse value on the 256-step color-values scale. For example, a pixel in a positive image with a value of 255 is changed to 0, and a pixel with a value of 5 is changed to 250. For a source video stream 8 having grayscale content, the inversion function 30 may reverse the grayscale color values based on the 256-step grayscale color value scale by inverting the grayscale values. The output of the inversion function 30 is a first modified video stream 36, having frames with the inverted color values for the pixels in the source video stream 8. In this way, the inversion process may alter the chrominance and luminance of the pixel values 180 degrees.

The desaturation process 38 may be applied to desaturate the color values for the pixels in the first modified video stream 36, producing a second modified video stream 40 with the pixel values in the inverted first modified video stream 40 being desaturated at full desaturation or less than full desaturation, where desaturation makes the image less colorful. In embodiments where the source video stream 8 is in grayscale or black-and-white, the desaturation process 38 may not be applied to the inverted video stream 36.

The overlay process 42 merges the second modified video stream 40 and the source video stream 8 by overlaying the frames of the second modified video stream 40, e.g., the inverted and desaturated source video stream 8, onto the frames of the source video stream 8 at an opacity less than 100%, such as between 25-80%, depending on the desired effect, to produce the final supplemental video stream 12, which may comprise a depth map. The opacity level determines the degree to which the layer being superimposed, i.e., the second modified video stream 40, obscures or reveals the layer beneath, such as the source video stream 8. A layer with 1% opacity appears nearly transparent, while one with 100% opacity appears completely opaque.

In an alternative flow of operations, the desaturation process 38 may apply to the source video stream 32 so that the first modified video stream 36 comprises a desaturated source video stream 8, and then the inversion process 34 may apply to the desaturated source video stream to produce the second modified video stream 40, being desaturated then inverted.

The video pre-processor 10 further includes an overlay mapping 44 used to adjust the opacity level at which the modified video stream 40 is overlaid onto the source video stream 8 to control the depth map information for objects in the frames; a luminance mapping 46 used to adjust the color values pixels in the source video stream 8 to affect the depth information and whether the pixels appear more in the foreground or background; and a desaturation mapping 48 used to select the desaturation level used by the desaturation process 38.

The video pre-processor 10 may further include default parameters 49 providing default parameters for the desaturation process 38 and the overlay process 42, and other processes used to generate the supplemental video stream 12.

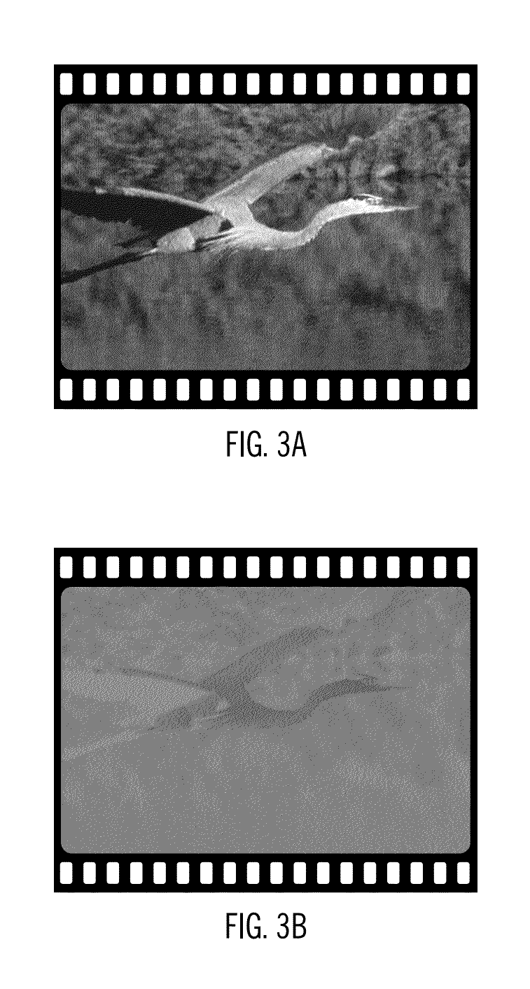

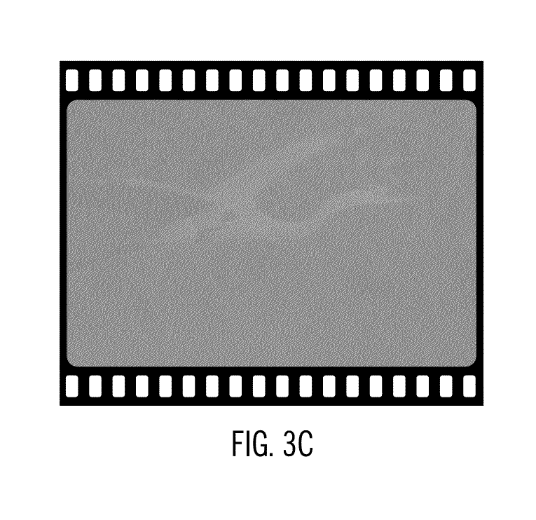

FIG. 3a illustrates an example of a frame from a source video stream. FIG. 3b illustrates an example of a frame comprising the inverted and desaturated frame of FIG. 3a. FIG. 3c illustrates an example of overlaying the frame of FIG. 3b onto the source frame of FIG. 3a to produce the depth information for the frame of FIG. 3c.

The video pre-processor 10 and its components 30, 34, 38, 42, 44, 46, 48, and 49 may be encoded in software executed by the processor 4 and/or may be encoded in one or more hardware devices, such as one or more Application Specific Integrated Circuits (ASICs). Further, the video processor 14 may be implemented in a separate software and/or hardware component than the video pre-processor 10, or may be implemented in the same software and/or hardware components in which the video-pre-processor 10 is implemented. In one embodiment, the video processor 14 and video pre-processor 10 may be implemented in the same physical or virtual computer 2, as shown in FIG. 1, or may be implemented in separate physical or virtual computers.

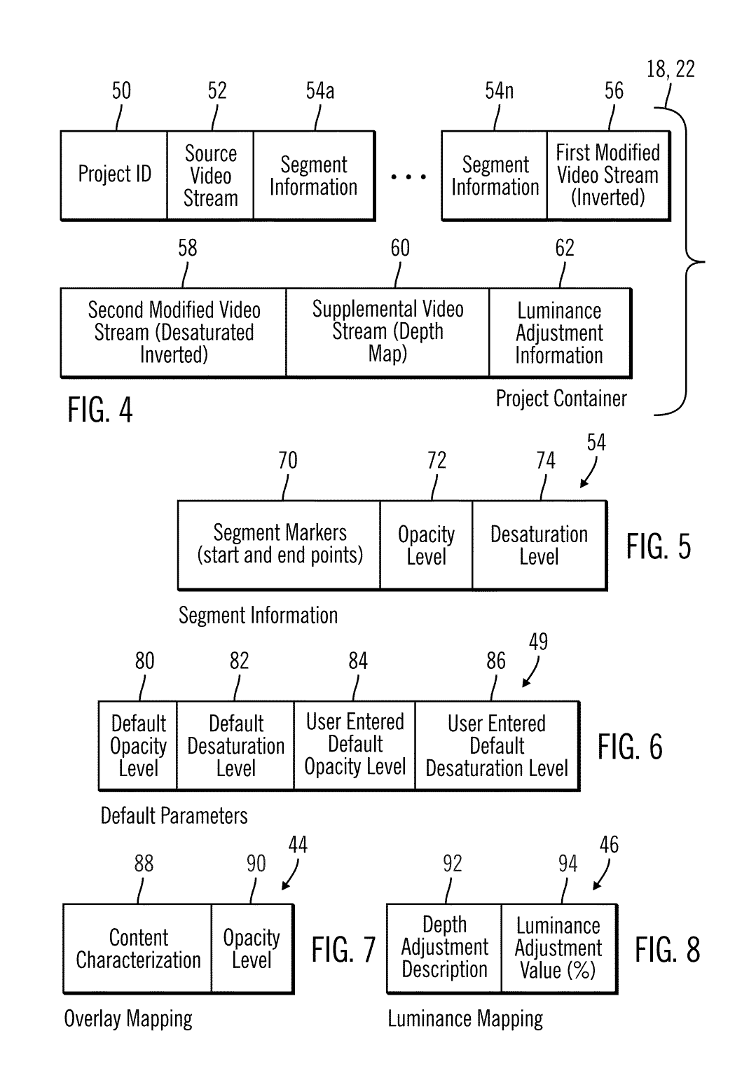

FIGS. 4, 5, 6, 7, 8, and 9 illustrate embodiments of data structures used by the video pre-processor 10 to store information related to the processing of a source video stream 8 to produce the supplemental video stream 12. The information in the data structures of FIGS. 4, 5, 6, 7, 8, and 9 may be stored in the memory 6 and the repository 22.

FIG. 4 illustrates an embodiment of an instance of a project container 18, 20, including a project identifier (ID) 50; identification of a source video stream 52 subject to the video pre-processing; segment information instances 54a . . . 54n providing user supplied settings for segments of consecutive frames, e.g., shots, in the source video stream 52; identification of a first modified video stream 56 (e.g., inverted or desaturated); identification of a second modified video stream 58 if produced (e.g., desaturated and inverted); identification of the supplemental video stream 60 being generated; and luminance adjustment information 62 produced by user adjustment input through the video pre-processor 10 user interface of the luminance of particular pixels in the source video stream 52 to control the depth information for images defined by the selected pixels in the supplemental video stream 12. The luminance adjustment information 62 may indicate pixels in frames of the source video stream 52 that the user selected change to the luminance, e.g., lighten or darken, and the adjusted luminance.

For instance, in depth map embodiments where lighter color values indicate a pixel is more in the foreground and darker color values indicate the pixel is more in the background, because of the inversion of the source image, reducing the luminance (darkening the pixels) in the source video stream 8 causes the depth information to indicate that the darkened pixels appear more in the foreground in the final depth map and increasing the luminance (lightening the pixels) in the source video stream 8 causes the depth information to indicate that the lightened pixels appear more in the background, due to the inversion. The luminance adjustment information 62 may provide sufficient information on the luminance adjustment to pixels in the frames of the source video stream 8 to allow the user to review and modify the luminance adjustments.

In certain embodiments the identifiers of the video streams 52, 56, 58, and 60 may comprise pointers to the actual video streams in the repository 22 or memory 6 or include the actual content of the video streams 52, 56, 58, and 60 that are identified.

FIG. 5 illustrates an embodiment of the segment information 54, comprising an instance of the one or more segment information 54a . . . 54n instances in the project container 18, 22. The project container 18, 22 may include zero or more instances of segment information 54. The segment information 54 includes segment markers 70 indicating a start and end frame in the source video stream 8 to identify a series of consecutive frames; a user entered opacity level 72 for use by the overlay process 42 to overlay the frames in the segment 70 on the corresponding frames in the source video stream 8; and a user entered desaturation level 74 for use by the desaturation process 38 to desaturate the frames in the segment 70 when processing the second modified video stream 40. The opacity 72 and desaturation 74 levels are optional and may not be provided.

The start and end frames for shots of frames may by determined by an automated shot detection process implemented in the video pre-processor 10 that determines start and end points of different shots in the source video stream 52. Alternatively, the segment boundaries may be manually designated by the user using a GUI of the video pre-processor 10.

FIG. 6 illustrates an embodiment of default parameters 49 including a default opacity level 80, default desaturation level 82, user entered default opacity level 84, and user entered default desaturation level 86. The default levels 80 and 82 are used by the desaturation 32 and overlay processes 34 if the user does not provide specific overlay and desaturation levels for particular segments in segment information. The user may modify the pre-configured opacity 80 and/or desaturation levels 84 to produce user entered default levels 86 and/or 88 if specified levels are not provided for specific segments.

FIG. 7 illustrates an embodiment of an overlay mapping 44, which includes a content characterization 88 and corresponding opacity level 90 for overlaying the modified video stream 40 onto the source video stream 8.

FIG. 10 illustrates an example of the overlay mapping 44, which includes a content characterizations and associated overlay levels for the different content characterizations. In embodiments where a lighter value in the depth map 12 indicates an image is more in the foreground and a darker value indicates more in the background relative to other values in the depth map, inverting the source image reverses the depth information provided by the colors in the source video stream 8, by making lighter colors darker, i.e., more in the background, and darker colors lighter, i.e., more in the foreground. Because this inverted modified video stream 40 is overlaid onto the source video stream 8 to produce the final depth map 12, using a greater opacity makes the color values in the modified video stream 40 more prominent in the final depth map 12, whereas reducing the opacity level (i.e., increasing transparency) gives more weight to the color values in the underlying source video stream 8 in the final depth map 12. In this way, a relatively higher opacity level makes lighter values in the source video stream 8, which appear as darker values in the inverted modified video stream 40, more dark in the final merged depth map 12, and makes darker values in the source video stream 8, which appear as lighter values in the inverted modified video stream 40, more light in the final merged depth map 12 by providing more weight to the color values in the inverted modified video stream 40. Whereas, a relatively lower opacity level makes lighter values in the source video stream 8, which appear as darker values in the inverted modified video stream 40, more light in the final merged depth map 12 and makes darker values in the source video stream 8, which appear as lighter values in the inverted modified video stream 40, more dark in the final merged depth map 12 by providing relatively more weight to the color values in the source video stream 8.

In the example luminance mapping of FIG. 10, the content characterization of “outdoor sunny day” specifies an opacity level of 100%, which results in using the second modified video stream 40 as the depth map 12, which means the overlay process 42 does not have to perform the actual overlay operation, and instead generate the inverted and desaturated video stream 40 as the depth map. The content characterization of: “outdoor cloudy day” specifies a 52% opacity level; “nighttime outdoors” specifies a 48% opacity level; and “indoor with natural light” specifies a 50% opacity level.

FIG. 8 illustrates an embodiment of the luminance mapping 46, which includes a depth adjustment descriptor 90 and a luminance adjustment value 92 associated with the descriptor 90. The depth adjustment descriptor 90 provides a depth description of the extent to which selected pixels in one or more frames of the source video stream 8 are moved to the foreground or background. The luminance adjustment value 92 may indicate a percentage that the current luminance value of the pixels are adjusted upward or downward.

FIG. 11 illustrates an example of the luminance mapping 46 having depth adjustment descriptors 90 indicating a relative extent to which pixels are moved to the foreground or background, where the first relative amount may indicate a minor adjustment and the second relative amount may indicate a more significant adjustment forward or backward in the depth. In embodiments where a lighter color in the depth map indicates the pixels are more in the foreground and a darker color indicates the pixels are more in the background, a negative luminance adjustment value darkens the pixels in the source video stream 8, making the pixels lighter in the inverted modified video stream 36 such that the generated depth information 12 indicates the pixels are more in the foreground. A positive luminance adjustment value lightens the pixels in the source video stream 8, making the pixels darker in the inverted modified video stream 36 such that the generated depth information 12 indicates the pixels are more in the background.

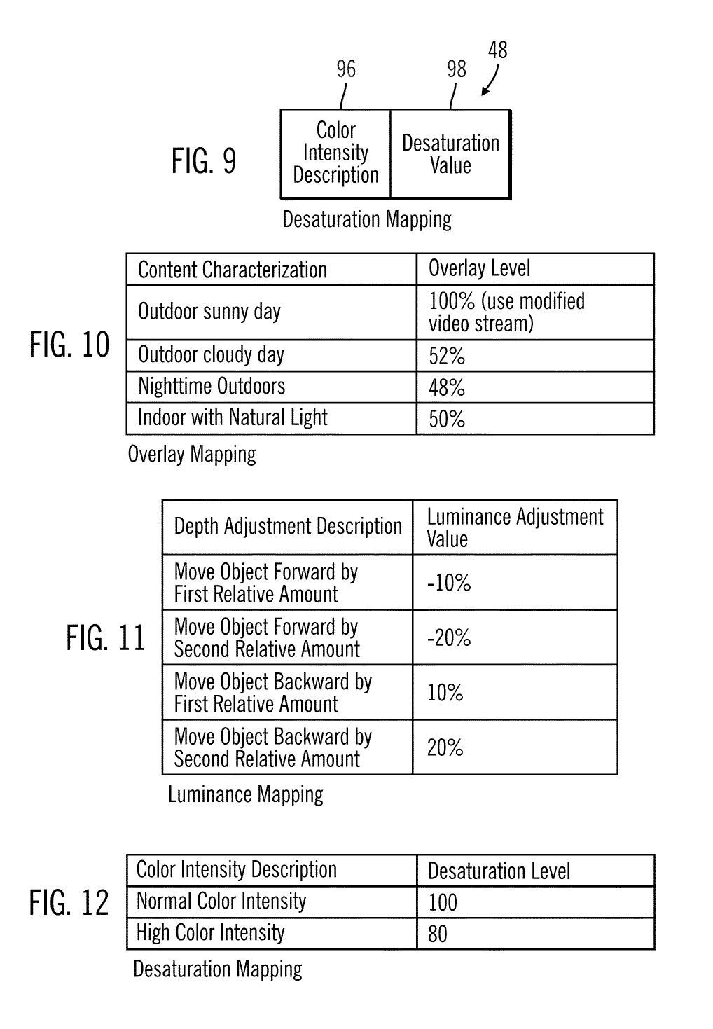

FIG. 9 illustrates an embodiment of a desaturation mapping 48, which includes a color intensity description 94 and a desaturation value 96 associated with the color intensity description. The color intensity description 94 provides a description of the brightness or colorfulness of the colors in frames of the source video stream 8. The desaturation value 96 provides desaturation of the first modified video stream 36 to be overlaid onto the source video stream 8 to form the depth map 12 for higher color intensities of the source video stream 8 frames in order to reduce the color effect on the depth information, i.e., prevent more intensely colorful pixels in the source video stream 8 from appearing more in the foreground of the output.

FIG. 12 illustrates an example of the desaturation mapping 48 providing color intensity descriptions of normal and high and different desaturation levels, where for normal color intensity desaturation is 100 or full desaturation, which removes the color from the pixels in the second modified video stream 40 to be overlaid, and for high color intensity saturation is less than full, e.g., 80, to remove less of the color from the second modified video stream 40. Less desaturation provides a modified video stream 40 with less of the color value removed to provide greater offset of the colors in the source video stream 8 during the overlay process 42, resulting in a reduction of the effect of the colors from the source video stream 8 in the final depth map 12.

The example mappings of FIGS. 10, 11, and 12 provide examples of descriptions and characterizations and specific levels and values for the video pre-processing processes. Descriptions and values may be configured in the video pre-processor 10 other than those shown based on empirical observations and analyses.

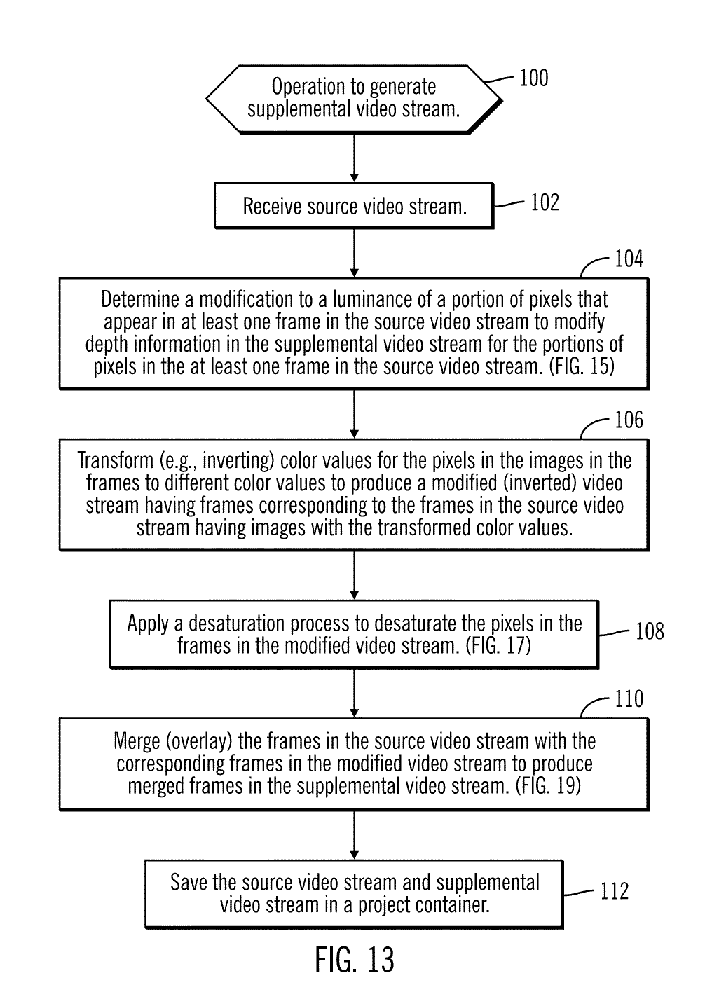

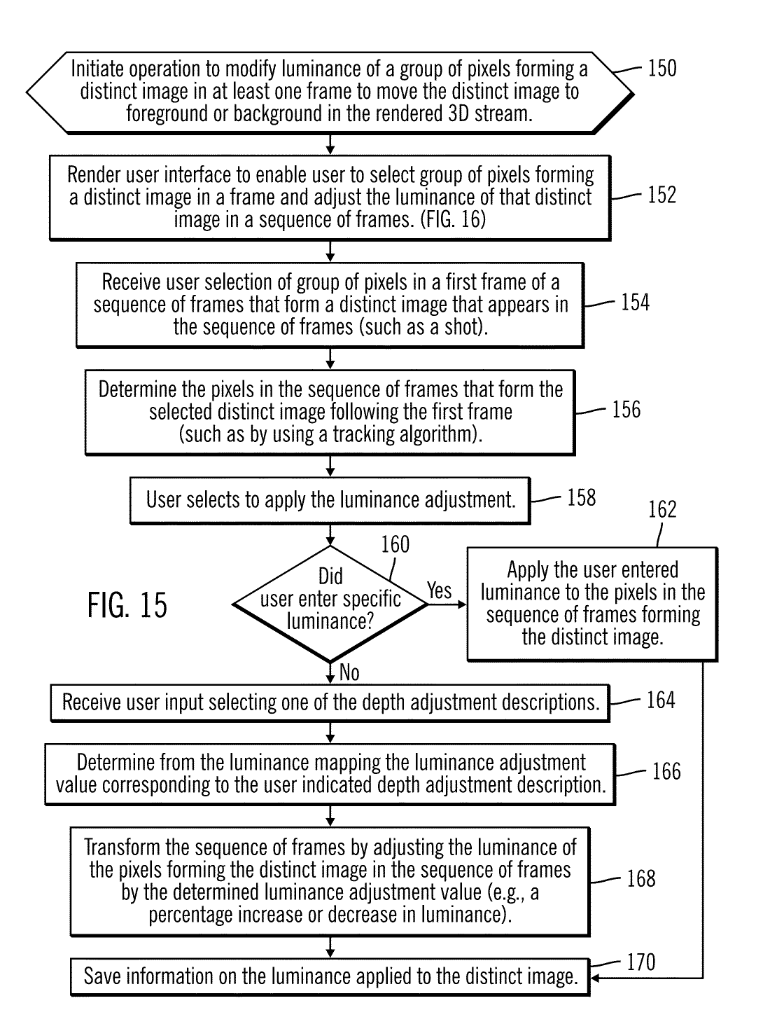

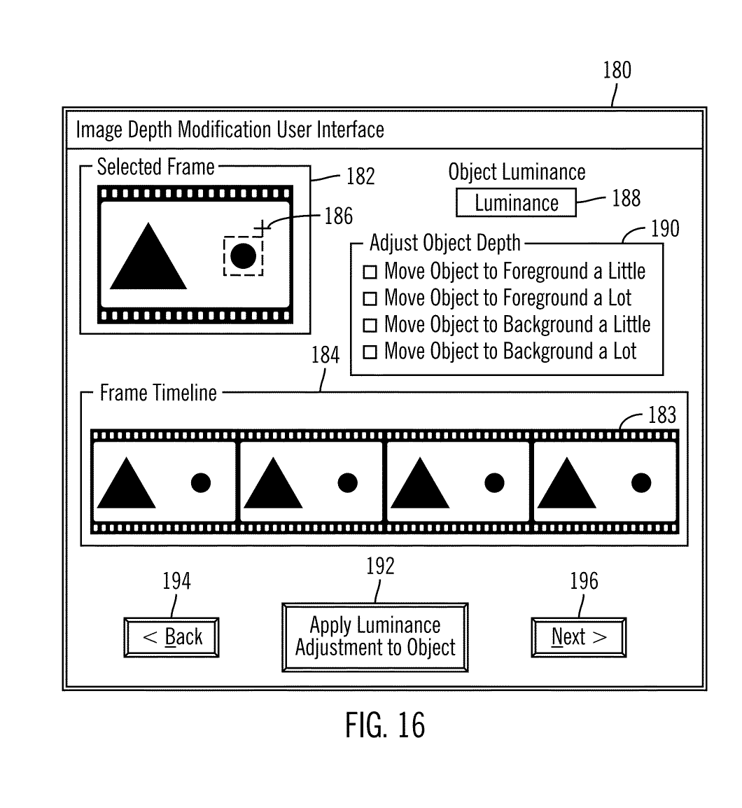

FIG. 13 illustrates an embodiment of operations performed by the video pre-processor 10 to generate the supplemental video stream 12 from the source video stream 8. Upon initiating the generating process (at block 100), the video pre-processor 10 receives (at block 102) the source video stream 8. If the video pre-processor 10 receives from a user, via a GUI rendered by the video pre-processor 10, such as shown in FIG. 16, adjustments to the luminance of pixels defining an image in the frames, then the video pre-processor 10 determines (at block 104) a modification to a luminance of the user selected portion of pixels that appear in at least one frame in the source video stream to modify depth information in the final supplemental video stream 12 for the selected pixels. The pixels that are subject to the luminance adjustment may define an image that appears in multiple frames forming a video shot. FIG. 15 provides an embodiment of operations to adjust the luminance of pixels defining an image in the source video stream 8.

The video pre-processor 10 transforms (at block 106), e.g., inverts using the inversion process 34, color values for the pixels in the images in the frames of the source video stream 8 to different color values, e.g., inverted color or grayscale values (for black-an-white source), to produce a modified (inverted) video stream 36 having frames corresponding to the frames in the source video. In alternative embodiments, transformation operations other than inversion may be performed on the color values.

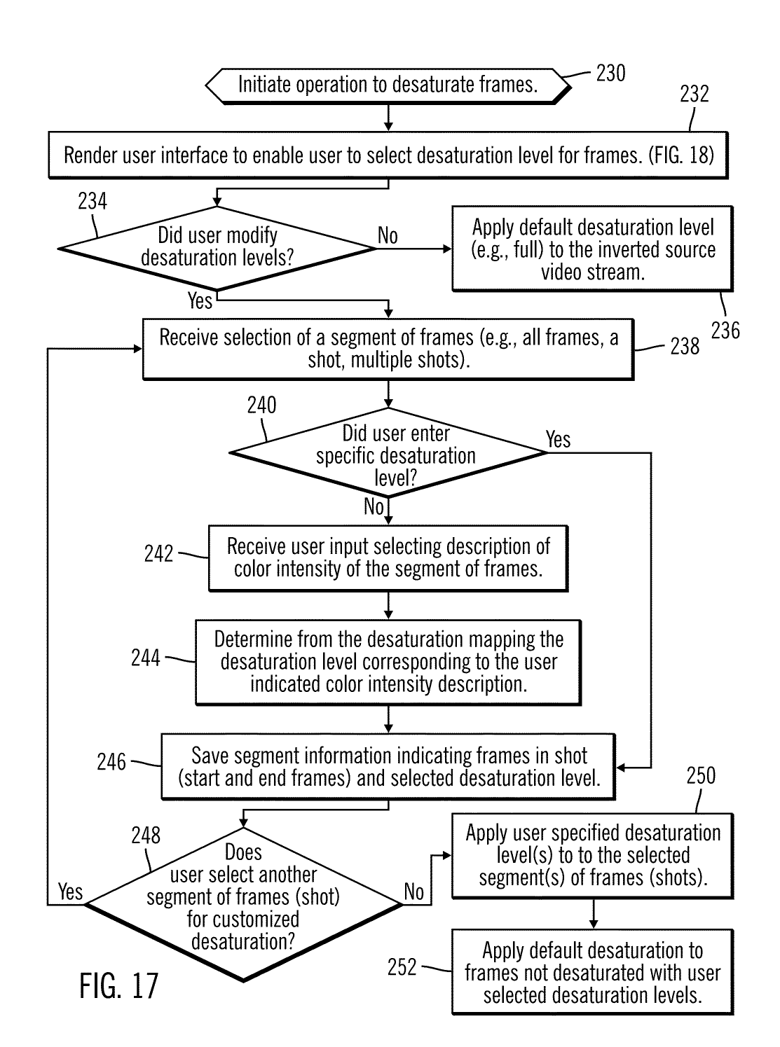

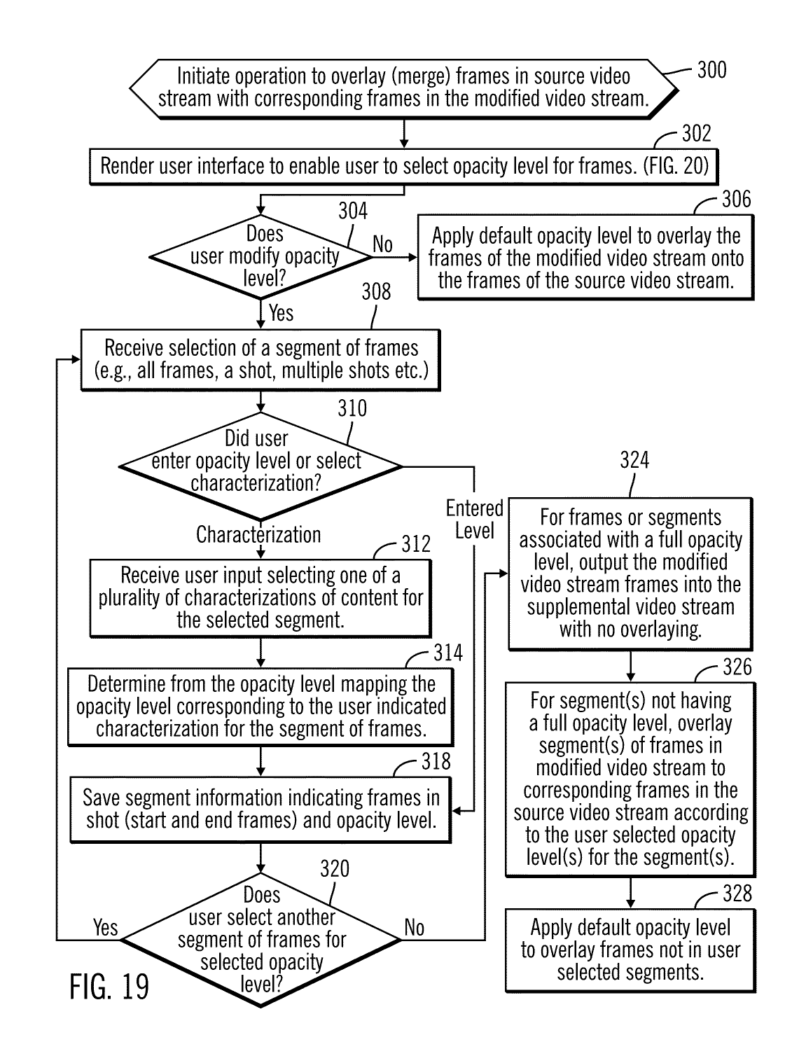

The video pre-processor 10 applies (at block 108) a desaturation process 38 to desaturate the pixels in the frames in the modified video stream 36 to produce a desaturated and inverted modified video stream 40. FIG. 17 provides further details on the desaturation process 38. The frames in the source video stream 8 (which may have been subject to the luminance adjustment process 30) are then merged (at block 110) with the corresponding frames in the second modified video stream 40, such as by overlaying the frames in the second modified video stream 40 onto the corresponding frames in the source video stream 8 using a determined opacity level. FIG. 19 provides further details on operations to overlay the frames. Information on the source video stream 8 and supplemental video stream 12, including configuration settings used during the vide pre-processing operations, may be stored (at block 112) in the project container 18.

After being generated, the supplemental video stream 12 may be presented to the video processor 14 with the source video stream 8 to use to generate an output video stream 16 in a different format than the source, such as frames capable of being rendered for 3D viewing.

In certain embodiments, the video pre-processor 10 may present the user the option to invoke the operations of FIG. 13 to produce the supplemental video stream 12, i.e., depth map, without any user interaction with the process operations, other than invocation. The video pre-processor 10 may further enable the user to interact with the pre-processing operations and customize values used by the processes 30, 34, 38, and 42 with respect to the generation of the depth map. FIGS. 15-20 illustrates embodiments where the user may interact with one or more of the video pre-processor 10 components to customize and control depth map generating operations, such as luminance adjustment 30, the desaturation process 38, and the overlay process 42.

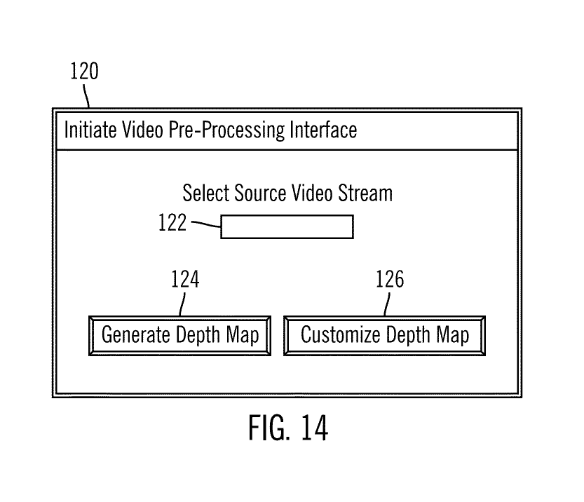

FIG. 14 illustrates an embodiment of a GUI 120 having an entry box 122 in which the user may select a source video stream file 8 to process from the repository 22 or some other local or network storage. Selection of a generate depth map button 124 would automatically cause the operations at blocks 102, 106, 108, 110, and 112 in FIG. 13 to generate the supplemental video stream, depth map, and save information in the project container 18 without user interaction in the depth map 12 generation process. In certain embodiments, the generate depth map 124 button may implement a “single-click” invocation of the video pre-process to automatically generate the depth map 12 from the selected input video stream 8 according to the operations in FIG. 13. Selection of the customize depth map button 126 would allow the user to interact with the video pre-processor 10 operations to customize settings and depth information used in producing the final depth map 12.

FIG. 15 illustrates an embodiment of operations to modify the luminance of pixels in the frames of the source video stream 8 to provide fine tune control over the depth information for those pixels in the supplemental video stream 12. Upon initiating the luminance modification operation (at block 150), the video pre-processor renders (at block 152) on a display device an image depth modification GUI 180, such as shown in FIG. 16, that enables the user to select groups of pixels forming a distinct image in a frame of the source video stream 8 for depth adjustment.

In the image depth modification GUI 180 (FIG. 16), a selected frame panel 182 displays a frame the user has selected, using an input device such as a mouse, keyboard, touch sensitive screen, from a sequence of frames 183 displayed in a frame timeline panel 184, showing a sequence of frames from the source video stream 8. The user may use a user interface device to select a region of pixels in the frame, such as shown by the selected region 186, in the frame panel 182, that define an object or image. After selecting a group of pixels defining an object 186, the user may enter a specific luminance value in the luminance edit box 188 or select a description of a relative adjustment of depth for the selected pixels 186 from the adjust object depth panel 190. The descriptions in the adjust object depth panel 190 may correspond to descriptions in the luminance mapping 46 for which there are associated adjustment percentages of the luminance. The user may select the apply luminance button 192 to apply the selected luminance adjustment, indicated in GUI controls 188 or 190, to the pixels defining the object in a sequence of frames in the source video stream 8 in which the defined image appears. The user may further select the back 194 or next 196 button to move forward or backward in the video pre-processor process. For instance, selecting the next button 196 may proceed to the inversion process 34. The user may move forward to the inversion process 34 without adjusting the luminance of pixels in the source video stream 10 through the GUI graphical controls 186, 188, 190, and 192.

After rendering (at block 152) the GUI panel 180, the video pre-processor 10 may receive (at block 154) user selection of a group of pixels in a first frame of a sequence of frames that form a distinct image that appears in the sequence of frames (such as a shot), e.g., object 186 (FIG. 16). The video pre-processor 10 may then determine (at block 156) the pixels in the sequence of frames that form the distinct image following the first frame. The video pre-processor 10 may use a tracking algorithm to track the location of the pixels forming the defined image the user selected in the first frame in the sequence of frames following the first frame. In this way, the user selects a sequence of frames and pixels defining an object in a first frame of the sequence, and the video pre-processor 10 determines the pixel location of that defined image in the frames of the selected sequence following the first frame.

Upon the user selecting to apply the luminance adjustment, such as by selecting the apply button 192 (FIG. 16), the video pre-processor 10 determines (at block 160) whether the user entered a specific luminance, such as in the luminance entry box 188. If so, then the video pre-processor 10 applies (at block 162) the user entered luminance to the selected pixels 186 in the sequence of frames forming the distinct image. If (at block 160) the user did not enter a specific luminance, the video pre-processor 10 receives (at block 164) user input selecting one of the depth adjustment descriptions, such as one of the descriptions in the panel 190, and determines (at block 166) from the luminance mapping 46 the luminance adjustment 92 value corresponding to the user indicated depth adjustment description 88 (FIG. 8). The video pre-processor 168 transforms (at block 168) the determined sequence of frames by adjusting the luminance of the pixels forming the distinct image in the sequence of frames by the determined luminance adjustment value (e.g., a percentage increase or decrease in luminance). Modifying the luminance value may comprise adjusting the luminance of the pixels by the percentage adjustment value associated with the selected depth adjustment description or setting the luminance value for the pixels to the user entered specific values. Information on the luminance applied to the pixels forming the distinct image is saved in the luminance adjustment information 62 of the project container 18 for the current video project.

The user may enter different luminance adjustments multiple times through the operations at block 154-168 to select different groups of pixels, i.e., defined images, in the same and different sequences of frames for different luminance adjustments.

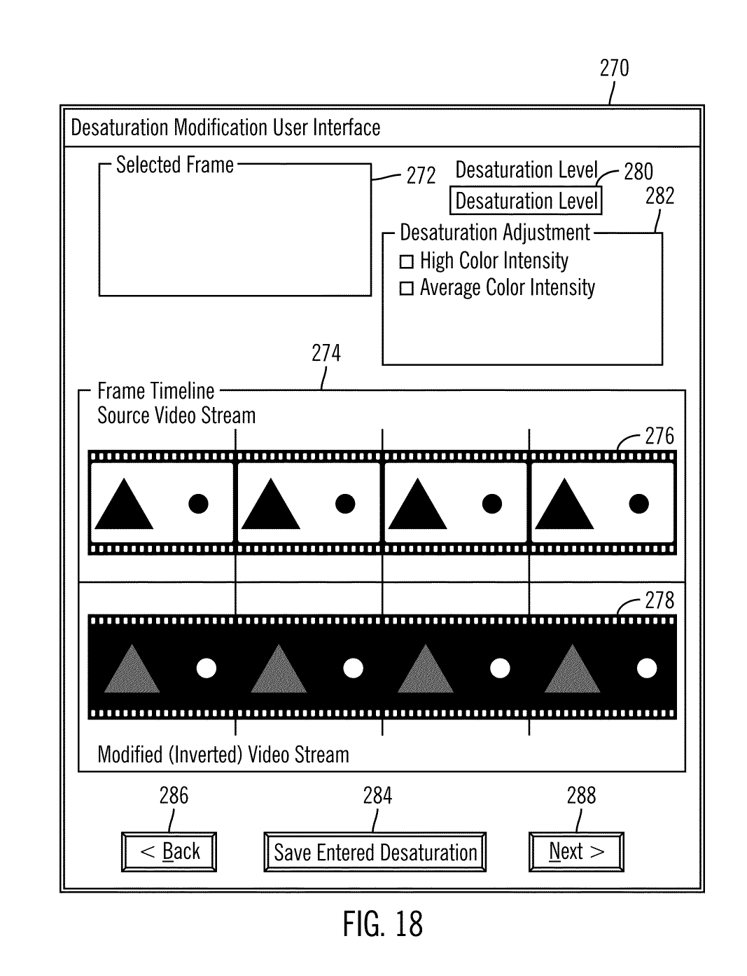

FIG. 17 illustrates an embodiment of operations performed by the video pre-processor 10 to desaturate frames in the first modified video stream 36 or inverted video stream. Upon initiating (at block 230) the desaturation process 38 after (or before) the inversion process 34, the video pre-processor 10 renders (at block 232) a desaturation modification GUI, such as shown in FIG. 18, to enable the user to select a desaturation level for frames in the modified source video stream being generated.

In the desaturation modification GUI 270, a selected frame panel 272 displays a frame the user has selected, using an input device such as a mouse, keyboard, touch sensitive screen, from one of the sequences of frames 276 and 278 displayed in a frame timeline panel 274, showing sequences of frames from the source video stream 276. The frame timeline panel 284 further shows the corresponding sequence of frames 278 in the first modified video stream 36 to which the desaturation will apply. The user may enter a specific desaturation level in the desaturation luminance edit box 280 or select a color intensity description for the sequence of frames 278 from the desaturation adjustment panel 282. The color intensity descriptions in the desaturation adjustment panel 282 may correspond to descriptions 94 in the desaturation mapping table 48 for which there are associated desaturation values or levels 96 (FIG. 9) to apply. The user may select a save desaturation button 284 to save the selected desaturation level for selected frames 278. The user may further select a back 286 or next 288 button to move backward or forward in the video pre-processor process. For instance, selecting the next button 288 proceeds to the overlay process 42. The user may move forward to the overlay process 42 without adjusting the desaturation of the second modified video stream 40 through the graphical controls 280, 282 and 284. The user may select the save button 284 multiple times to select different desaturation levels for different sequences of frames, e.g., shots.

After rendering (at block 232) the GUI panel 270, if (at block 234) the user has not selected to modify the desaturation levels and proceeds in the process, such as by selecting the next button 288, then the desaturation process 38 applies (at block 236) the default desaturation level 82, 86 (e.g., full) to the inverted source video stream 36 to produce the inverted and desaturated video stream 40. If (at block 234) the user has selected to modify the desaturation levels, then the desaturation process 38 receives (at block 238) selection of a segment of frames, such as all frames in the inverted video stream 36 or a segment of frames, such as a shot. If (at block 240) the user did not enter a specific desaturation level, such as in desaturation entry box 280, but instead selects one of the color intensity descriptions, such as in panel 282 of FIG. 18, then the desaturation process 38 receives (at block 242) user input selecting a description of color intensity of the selected segment of frames and determines (at block 244) from the desaturation mapping 48 the desaturation value/level 96 corresponding to the selected color intensity description 94. The selected frames in the shot and the selected desaturation level are saved (at block 246) as segment markers 70 and desaturation level 74 in the segment information 54 in the project container 18 being generated. If (at block 248) the user selects another segment of frames, such as a shot, for a customized desaturation, then control proceeds back to block 238 to obtain user selected desaturation information for another segment. Otherwise, if (at block 248) the user has completed entering desaturation information for segments, such as by selecting the next button 288, then the desaturation process 38 applies (at block 250) the user specified desaturation levels 74 to the selected segments of frames 70. The default desaturation 82, 86 is applied (at block 252) to frames not desaturated with user selected desaturation levels (at block 250).

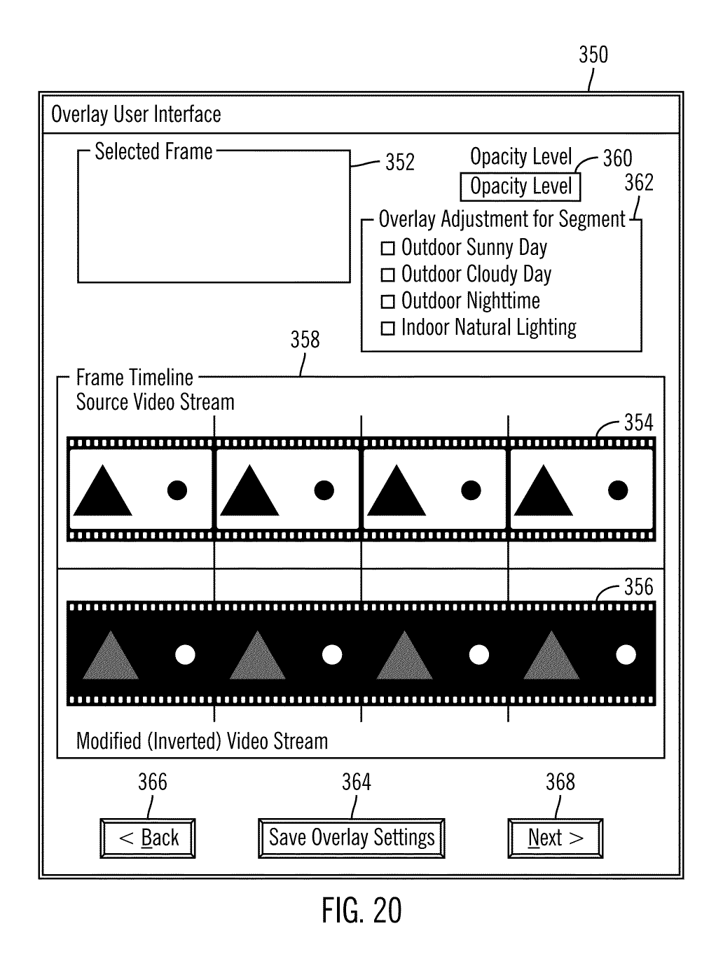

FIG. 19 illustrates an embodiment of operations performed by the video pre-processor 10 and overlay process 42 component to merge, e.g., overlay, the resulting modified video stream 40 with the source video stream 8 to produce the supplemental video stream 12 or depth map. Upon initiating (at block 300) the overlay operation, the overlay process 42 renders (at block 302) an overlay user interface 250 (FIG. 20) to enable the user to select opacity levels for the frames.

The overlay user interface 350 includes a selected frame panel 352 to display a frame the user has selected from either a sequences of frames from the source video stream 354 or a sequence of frames from the second modified video stream (inverted and desaturated) 356 displayed in a frame timeline 358 The user may enter a specific opacity level for overlaying the modified video stream 40 onto the source video stream 8 in the opacity level edit box 360 or select a characterization of the content of the sequence of frames 352 from an overlay adjustment panel 362. The content characterizations in the overlay adjustment panel 362 may correspond to content characterizations 88 in the overlay mapping 44 for which there are associated opacity levels 90 (FIG. 7) to apply. The user may select the save button 364 to save the selected opacity level for the selected frames in the segment information 54 indicating the segment markers 70 and the overlay level 74 (FIG. 5) that was entered. The user may further select the back 366 or next 368 button to move backward or forward, respectively, in the video pre-processor 10 process. For instance, selecting the next button 368 proceeds to overlay the modified video stream 40 onto the source video stream 8 to produce the supplemental video stream 12. The user may move forward to perform the overlaying without adjusting the opacity level of the second modified video stream 40. The user may select the save button 362 multiple times to select different opacity levels for different segments 54a . . . 54n (FIG. 4) of sequences of frames, e.g., shots.

After rendering (at block 302) the GUI panel 350 and receiving user selection, the overlay process 42 determines (at block 304) whether the user has modified the opacity level, such as by using graphical controls 360 or 362. If there was no modification to the opacity levels, then the overlay process 42 applies (at block 306) the default opacity level 80 and 84 to overlay the frames of the modified video stream 40 onto the frames of the source video stream 8. If (from the YES branch of block 304) the user provided customized opacity levels, then the overlay process 42 receives (at block 308) selection of a segment of frames (e.g., all frames, a shot, multiple shots etc.). If (at block 310) the user selected a characterization of the content, such as in the overlay adjustment panel 362 (FIG. 20), then the overlay process 42 receives (at block 312) user input selecting one of the plurality of characterizations, such as in panel 362, and determines (at block 314) from the opacity level mapping 44 the opacity level 90 corresponding to the user indicated characterization 88 for the selected segment of frames. Information on the selected segment and opacity level are saved (at block 318) in the segment markers 70 and opacity level 72 field in the segment information 54 (FIG. 5) maintained in the project container 18 for the current pre-processing project. If (at block 310) the user entered the opacity level, such as in opacity level box 360, then control proceeds to block 318 to save in the segment information 54 the user entered opacity level in field 72 for the selected segment 70.

If (at block 320) the user selects another segment of frames (e.g., shot) for a selected opacity level, then control proceeds back to block 308, such as by the user selecting the save button 364 in the overlay user interface 350. Otherwise, if (from the NO branch of block 320) the user indicates completion of entering customized overlay levels for segments of frames, such as by selecting the next button 368 in the overlay user interface 350, then for frames or segments associated with a 100% opacity level, i.e., full opacity, the overlay process 42 outputs (at block 324) the modified video stream frames 40 into the corresponding supplemental video stream 12 with no overlaying. For segment(s) 70 having an opacity level 72 less than full opacity, the overlay process 40 overlays (at block 326) the segment(s) of frames 70 in the modified video stream 40 onto to the corresponding frames in the source video stream 8 according to the user selected opacity level(s) 72 for the segment(s) 70. The default opacity level 80, 84 is applied (at block 328) to overlay frames not in user selected segments 70.

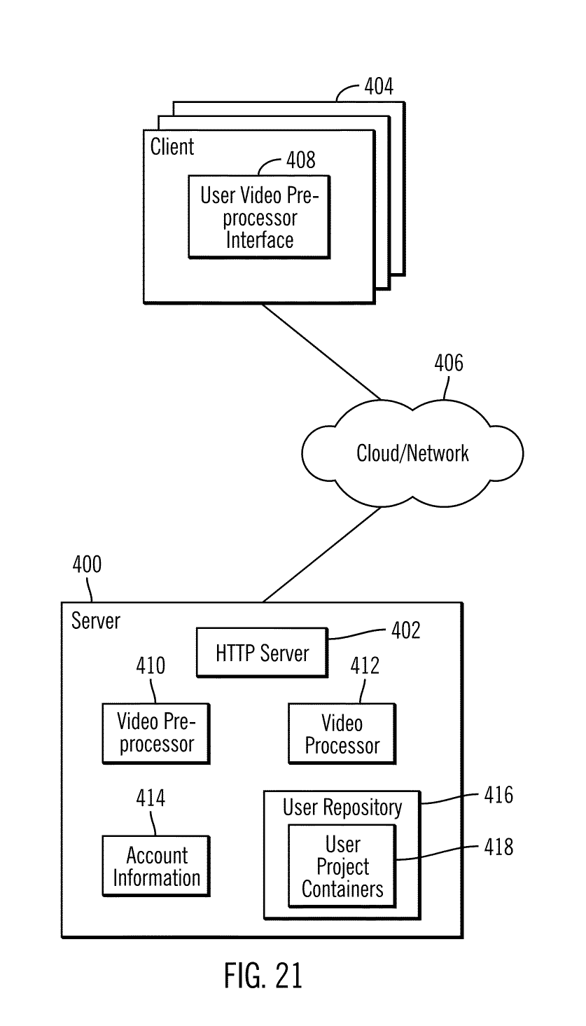

FIG. 21 illustrates an embodiment of a cloud or network computing model in which the video pre-processor and video processor embodiments may be deployed as a service to end users. In the cloud computing environment, a server 400 may include a Hypertext Transport Protocol (HTTP) server 402 to handle requests from client computers 404 over the cloud/network 406 to provide video pre-processor and video processor services. The client computers 404 include a video pre-processor interface 408 to enable the clients 404 to transmit source video streams 8 to the HTTP server 402 for video pre-processing at the server 400. The video pre-processor interface 408 may comprise an HTTP client, such as an Internet web browser, to communicate with the HTTP server 402. Protocols other than HTTP may be used to allow the clients 404 and server 400 to communicate over the cloud 406. The cloud 406 may comprise one or more networks, such as the Internet, an Intranet, and other networks, etc.

The server 400 includes a video pre-processor 410 component 4, such as the video pre-processor 10 described above, to provide video pre-processor services to the clients 404 to generate supplemental video streams 12, such as depth maps. The clients 404 may then submit the depth maps they receive from the server 400 to a third party video processor program for video processing, such as conversion of 2D to 3D video. The server 400 may further include a video processor 412, such as video processor 14 described above, to provide video processor services to the clients 404 to process both the source videos stream 8 and supplemental video stream 12 (depth map) to produce the output video stream 16, e.g., 3D output, to return to the client 404.

The server 400 may further include account information 414 for registered users of the video pre-processor 410 and/or video processor 412 services, used for communicating with users, billing, and providing of the services. The server 400 may further include a user repository 416 in which user project container 418, such as project containers 18, 20 are stored for later retrieval by the user to use any customized settings to produce the supplemental video stream 12 and output video stream 16.

In one embodiment, the server 400 may only provide video pre-processor 410 services to generate the supplemental video stream 12 that the user may then independently use in the video process. In a further embodiment, the server 400 may provide both video pre-processor 410 and video processor 412 services.

In one embodiment, the video pre-processor 10 may be deployed as a computer program product distributed and delivered to users to generate the supplemental video stream 12 for use with third party video processor programs and services. Alternatively, the supplemental video stream 12 may be submitted to a server 400 to provide the video processor 412 services using the depth map generated at the client 404. In further embodiments, the video pre-processor 10 may be packaged with the video processor 14 in a single computer program product that performs both the video pre-processing and video processing.

In one embodiment, the video pre-processor 10 and video processor 14 may be included in a computer program product to generate 3D output for later viewing and distribution. In a further embodiment, the described video pre-processor 10 and video processor 14 may be deployed within a viewing device, such as a television, tablet computer, smart phone, etc., including a 3D player, to provide real time conversion of 2D video streams to 3D video streams for real time 3D viewing.

Described embodiments provide techniques for pre-processing a source video stream to produce a supplemental video stream, such as a depth map, for use in transforming the source video stream in a first type of output to an output video stream in a second type of output, such as 3D. In described embodiments, the color values for the frames in the source video stream are transformed into a modified video stream, such as by using a process such as inversion and desaturation of the pixel color values in the source video stream. This modified video stream is then merged, such as overlaid, with the source video stream to produce the supplemental video stream, or depth map, for use with the source video stream in a video process, such as 2D to 3D conversion.

Described embodiments provide an automated technique requiring minimal user involvement to generate a depth map from a source video stream using automated video—pre-processing processes, such as inversion, desaturation, and overlaying, without the need for the user to manually create numerous depth map frames.

Described embodiments further provide techniques for the user to customize the video pre-processor operations by selecting specific pixels defining an image in one frame to indicate depth information for that defined image in a sequence of frames.

Further, the user may customize video pre-processor operations by characterizing the content of the source video stream to optimize the depth map creation process for the specific source video content. The customization operations to optimize the depth map creation involves considerably less time and labor to produce a desirable depth map than prior art techniques requiring the user to manually create depth maps.

The described operations may be implemented as a method, apparatus or computer program product using standard programming and/or engineering techniques to produce software, firmware, hardware, or any combination thereof. The described operations may be implemented as code maintained in a “computer readable storage medium”, where a processor may read and execute the code from the computer storage readable medium. A computer readable storage medium may comprise a device of storage media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. Those skilled in the art will recognize that many modifications may be made to this configuration without departing from the scope of the present invention, and that the article of manufacture may comprise suitable information bearing medium known in the art.

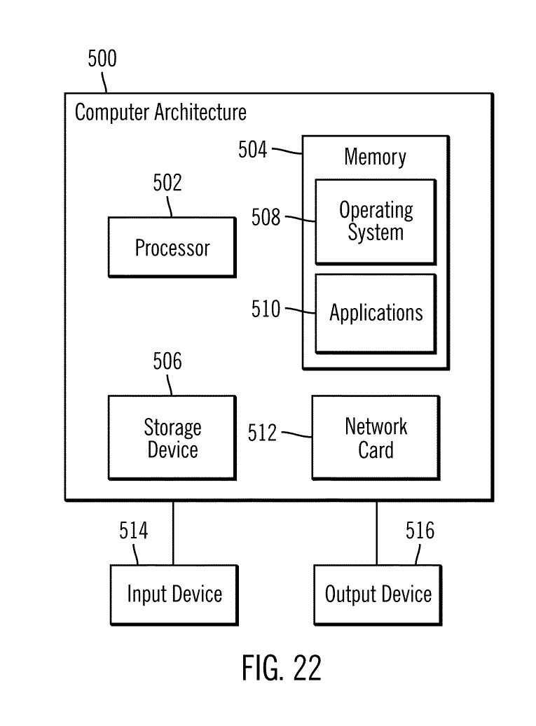

FIG. 22 illustrates an implementation of a computer architecture 500 that may be implemented at the computer 2 (FIG. 1), server 400 (FIG. 21), and client computers 404

(FIG. 22). The architecture 500 may include a processor 502 (e.g., one or more microprocessors and cores), a memory 504 (e.g., a volatile memory device), and storage 506 (e.g., a non-volatile storage, such as magnetic disk drives, solid state devices (SSDs), optical disk drives, a tape drive, etc.). The storage 506 may comprise an internal storage device or an attached or network accessible storage. Programs, including an operating system 508 and applications 510 stored in the storage 506 are loaded into the memory 504 and executed by the processor 502. The applications 510 may include the described video pre-processor 10, video processor 12, user video pre-processor interface 408 (FIG. 21) and other program components described above. The architecture 500 further includes a network card 512 to enable communication with a network. An input device 514 is used to provide user input to the processor 502, and may include a keyboard, mouse, pen-stylus, microphone, touch sensitive display screen, or any other activation or input mechanism known in the art. An output device 516, such as a display monitor, printer, storage, etc., is capable of rendering information transmitted from a graphics card or other component. The output device 516 may render the GUIs described with respect to FIGS. 14, 16, 18, and 20 and the input device 514 may be used to interact with the graphical controls and elements in the GUIs described with respect to FIGS. 14, 16, 18, and 20. The architecture 500 may be implemented in any number of computing devices, such as a server, mainframe, desktop computer, laptop computer, hand held computer, tablet computer, personal digital assistant (PDA), telephony device, cell phone, etc.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

The use of variable references, such as “a”, “n”, etc., to denote a number of instances of an item may refer to any integer number of instances of the item, where different variables may comprise the same number or different numbers. Further, a same variable reference used with different elements may denote a same or different number of instances of those elements.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of the figures show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A computer program product for processing a source video stream of frames of images providing a first type of output format to generate a supplemental video stream, wherein the source video stream and the supplemental video stream are processed by a video processor to produce an output video stream having a second type of output format, wherein the computer program product comprises a computer readable storage medium having computer readable program code embodied therein that executes to perform operations, the operations comprising:
processing the source video stream having a plurality of frames of digital images comprising an array of pixels in the first type of output format;
processing at least one of the frames of the source video stream by transforming color values for the pixels in the images in the at least one of the frames to different color values to produce a modified at least one frame; and
processing the modified at least one frame to generate the supplemental video stream having at least one frame corresponding to at least one of the frames in the source video stream.

2. The computer program product of claim 1, wherein the operations further comprise:
processing the source video stream and the supplemental video streams to produce the output video stream having frames corresponding to the frames in the source video stream in the second type of output format.

3. The computer program product of claim 1, wherein the first type of output format comprises a two-dimensional (2D) video output format and wherein the second type of output format comprises a three-dimensional (3D) video output format.

4. The computer program product of claim 3, wherein the at least one frame in the supplemental video stream provides depth information for the corresponding at least one of the frames in the source video stream.

5. The computer program product of claim 1, wherein the transforming of the color values for the pixels of the at least one of the frames in the source video stream comprises performing an inversion of the color values for the pixels to inverted color values.

6. The computer program product of claim 1, wherein the transforming of the color values for the pixels of the at least one of the frames in the source video stream comprises:
applying a desaturation function to the pixels in the at least one of the frames of the source video stream frame to produce the modified at least one frame of desaturated pixel values; and
inverting the desaturated pixel values in the modified at least one frame from the source video stream to generate into the supplemental video stream.

7. The computer program product of claim 1, wherein the transforming of the color values for the pixels of the at least one of the frames in the source video stream further comprises:
inverting the color values of the pixels in the at least one of the frames of the source video stream to inverted color values; and
applying a desaturation function to the inverted color values of the pixels to produce the modified at least one frame of the desaturated inverted color values of the pixels in the at least one of the frames in the source video stream.

8. The computer program product of claim 1, wherein the transforming of the color values for the pixels of the at least one of the frames from the source video stream includes:
determining a desaturation level; and
applying a desaturation process to desaturate pixels in the at least one of the frames by the determined desaturation level between full desaturation and no desaturation.

9. The computer program product of claim 8, wherein the operations further comprise:
determining shots of frames; and
receiving indicating indication of different desaturation levels for at least two of the shots, wherein the applying of the desaturation process comprises desaturating, for the determined shots of frames, the shot with the desaturation level indicated for the shot.

10. The computer program product of claim 8, wherein the operations further comprise:
maintaining a desaturation mapping associating desaturation values with descriptions of color intensity; and
wherein the determining of the desaturation level comprises:
receiving indication of one of the descriptions of color intensity for the at least one frame to be desaturated; and
determining from the desaturation mapping the desaturation level corresponding to the indicated color intensity description, wherein the determined desaturation level comprises the desaturation level determined from the mapping.

11. The computer program product of claim 10, wherein the descriptions of color intensity include at least one of high color intensity and average color intensity, wherein the high color intensity description is associated with a lower desaturation level than the average color intensity.

12. The computer program product of claim 33, wherein the merging of the frames comprises overlaying the frames in the modified video stream onto the source video stream at an opacity level less than 100%.

13. The computer program product of claim 1, wherein the computer program product is implemented in a server coupled to a plurality of computers over a network, wherein the operations at the server further comprise:
receiving, from one of the computers over the network, the source video stream with a request to produce video in the second type of output from one of the computers in the network, wherein the operations of processing the source video stream, producing the modified video stream, and merging the frames are performed in response to the request;
processing the source video stream and the supplemental video stream to produce the output video stream; and
transmitting the output video stream over the network to the computer initiating the request.

14. The computer program product of claim 1, wherein the computer program product is implemented in a server coupled to a plurality of computers over a network, wherein the operations at the server further comprise:
receiving, from one of the computers over the network, the source video stream with a request to produce the supplemental video stream, wherein the operations of processing the source video stream, producing the modified video stream, merging the frames, and generating the supplemental video stream are performed in response to the request; and
transmitting the supplemental video stream over the network to the computer initiating the request.

15. A system, comprising:
a processor; and
a computer readable storage medium including computer program code executed by the processor to perform operations, the operations comprising:
receiving a source video stream of frames of images providing a first type of output format;
processing the source video stream having a plurality of frames of digital images comprising an array of pixels in the first type of output format;
processing at least one of the frames of the source video stream by transforming color values for the pixels in the images in the at least one of the frames to different color values to produce a modified at least one frame; and
processing the modified at least one frame to generate a supplemental video stream having at least one frame corresponding to at least one of the frames in the source video stream.

16. The system of claim 15, wherein the first type of output format comprises a two-dimensional (2D) video output format, wherein the second type of output format comprises a three-dimensional (3D) video output format.

17. The system of claim 16, wherein the at least one frame in the supplemental video stream provides depth information for the corresponding frames in the source video stream.

18. The system of claim 15, wherein the transforming of the color values for the pixels of the at least one of the frames in the source video stream comprises performing an inversion of the color values for the pixels to inverted color values.

19. The system of claim 15, wherein the transforming of the color values for the pixels of the at least one of the frames in the source video stream further comprises:
inverting the color values of the pixels in the at least one of the frames of the source video stream to inverted color values; and
applying a desaturation function to the inverted color values of the pixels in the at least one of the frames of the source video stream to produce the modified at least one frame of the desaturated inverted color values of the pixels in the at least one of the frames in the source video stream.

20. The system of claim 15, wherein the transforming of the color values for the pixels of the at least one of the frames from the source video stream includes:
determining a desaturation level; and
applying a desaturation process to desaturate pixels in at least one of the frames by the determined desaturation level between full desaturation and no desaturation.

21. The system of claim 20, wherein the operations further comprise:
determining shots of frames; and
receiving indication of different desaturation levels for at least two of the shots, wherein the applying of the desaturation process comprises desaturating, for the determined shots of frames, the shot with the desaturation level indicated for the shot.

22. The system of claim 34, wherein the merging of the frames comprises overlaying the frames in the modified video stream onto the source video stream at an opacity level less than 100%.

23. A method, comprising:
receiving, in a computer memory, a source video stream of frames of images providing a first type of output format;
processing, in the computer memory, the source video stream having a plurality of frames of digital images comprising an array of pixels in the first type of output format;
processing, in the computer memory, at least one of the frames of the source video stream by transforming color values for the pixels in the images in the at least one of the frames to different color values to produce a modified at least one frame; and
processing the modified at least one frame to generate a supplemental video stream having at least one frame corresponding to at least one of the frames in the source video stream, wherein the at least one frame in the supplemental video stream is used with the source video stream to produce an output video stream in a second type of output format.

24. The method of claim 23, wherein the first type of output format comprises a two-dimensional (2D) video output format, wherein the second type of output format comprises a three-dimensional (3D) video output format.

25. The method of claim 24, wherein the at least one frame in the supplemental video stream provides depth information for the corresponding at least one of the frames in the source video stream.

26. The method of claim 23, wherein the transforming of the color values for the pixels of the at least one of the frames in the source video stream comprises performing an inversion of the color values for the pixels to inverted color values.

27. The method of claim 23, wherein the transforming of the color values for the pixels of the at least one of the frames in the source video stream further comprises:
inverting the color values of the pixels in the at least one of the frames of the source video stream to inverted color values; and
applying a desaturation function to the inverted color values of the pixels to produce the modified at least one frame of the desaturated inverted color values of the pixels in the at least one of the frames in the source video stream.

28. The method of claim 23, wherein the transforming of the color values for the pixels of the at least one of the frames from the source video stream includes:
determining a desaturation level; and
applying a desaturation process to desaturate pixels in at least one of the frames by the determined desaturation level between full desaturation and no desaturation.

29. The method of claim 28, further comprising:
determining shots of frames; and
receiving indication of different desaturation levels for at least two of the shots, wherein the applying of the desaturation process comprises desaturating, for the determined shots of frames, the shot with the desaturation level indicated for the shot.

30. The method of claim 35, wherein the merging of the frames comprises overlaying the frames in the modified video stream onto the source video stream at an opacity level less than 100%.

31. The method of claim 23, further comprising:
receiving, from over a network, the source video stream with a request to produce video in the second type of output, wherein the processing of the source video stream, processing the at least one of the frames, and processing the the modified at least one frame to generate the supplemental video stream are performed in response to the request;
processing the source video stream and the supplemental video stream to produce the output video stream; and
transmitting the output video stream over the network to the computer initiating the request.

32. The method of claim 23, further comprising:
receiving, from over a network, the source video stream with a request to produce the supplemental video stream, wherein the operations of processing the source video stream, processing the at least one of the frames, and processing the modified at least one frame to generate the supplemental video stream are performed in response to the request; and
transmitting the supplemental video stream over the network to the computer initiating the request.

33. The computer program product of claim 1, wherein the operations further comprise:
merging at least one of the frames in the source video stream with the corresponding modified at least one frame to produce at least one merged frame in the supplemental video stream.

34. The system of claim 15, wherein the operations further comprise:
merging at least one of the frames in the source video stream with the corresponding modified at least one frame to produce at least one merged frame in the supplemental video stream.

35. The method of claim 23, further comprising:
merging at least one of the frames in the source video stream with the corresponding modified at least one frame to produce at least one merged frame in the supplemental video stream.
